(19) United States
(12) Patent Application Publication
(10) Pub. No.: US 2023/0415408 A1
(43) Pub. Date: Dec. 28, 2023

(54) PROCESS FOR 3D PRINTING OF DENTAL ALIGNERS

(71) Applicant: BIXBY INTERNATIONAL CORPORATION, Newburyport, MA (US)

(72) Inventors: Marc GAGNON, Exeter, NH (US); Tim Glowik, Danvers, MA (US); Ethel Bermejo, Somerville, MA (US)

(73) Assignee: BIXBY INTERNATIONAL CORPORATION, Newburyport, MA (US)

(21) Appl. No.: 18/342,700

(22) Filed: Jun. 27, 2023

Related U.S. Application Data
(63) Continuation-in-part of application No. PCT/US2022/077355, filed on Sep. 30, 2022.
(60) Provisional application No. 63/251,216, filed on Oct. 1, 2021.

(51) Int. Cl. B29C 64/153; B29C 64/268; B29B 13/10

(52) U.S. Cl. CPC B29C 64/153; B29C 64/268; B29B 13/10; B33Y 10/00

(57) ABSTRACT

Methods of printing dental aligners with three-dimensional (3D) printing equipment and software include providing a thermoplastic material in powder form and forming the dental aligner from the powder form of the thermoplastic material, the thermoplastic material having enhanced materials properties. The thermoplastic material can be polysulfone and the resulting dental aligner can be substantially transparent and optionally tinted with a coloring agent.

### CROSS REFERENCE TO RELATED APPLICATIONS

This application is a continuation-in-part application of International PCT Application No. PCT/US22/77355, filed Sep. 30, 2022, and published as WO 2023/056425 A1 on Apr. 6, 2023 which claims priority to U.S. Provisional Patent Application No. 63/251,216 filed Oct. 1, 2021, the contents of which is incorporated herein by reference.

### FIELD OF THE INVENTION

The present invention relates to dental aligners, and more specifically, to methods of 3D printing dental aligners.

### BACKGROUND OF THE INVENTION

Like traditional braces, dental aligners are plastic orthodontic appliances that are molded to fit over the teeth and is used to correct their alignment, among other usages. Wearing them puts gentle pressure on the teeth so as to ever so slightly reposition them over time. Dental aligners can be clear or colored. Clear aligners are one of many technological advancements that have made orthodontic treatment less conspicuous, and one of many appliances that orthodontists use to move teeth and align jaws, along with other dental options.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention discloses various methods of direct printing retainers or dental aligners using three-dimensional (3D) printing processes. In other words, rather than creating a mold on which a film is subsequently thermoformed thereon for making the retainer or dental aligner, the actual retainer or dental aligner can be direct printed from the polymer powder (e.g., polysulfone powder) in a powder bed fusion (PBF) 3D printer chamber. In this embodiment, the polysulfone thermoplastic has enhanced creep properties (e.g., exhibits minimal creep) and excellent flexural modulus and strength thereby making it a material of choice for manufacturing retainers or dental aligners with effective and controlled movement of teeth.

In one embodiment, the resulting dental aligner or retainer produced using the presently disclosed embodiments can be printed in multiple, small layers (e.g., layer-by-layer along the z-axis direction) as facilitated by the PBF 3D printing process thereby eliminating rough surfaces. In these embodiments, no extra materials are needed in contrast to thermoforming plastic films onto molds whereby greater than about 60-% of the thermoplastic films have to be scrapped, not to mention the cost savings associated with eliminating the molds and their construction. In some embodiments, the resulting dental aligner or retainer produced using the presently disclosed methods can be tumble polished and sterilized. In yet some other embodiments, the SLS 3D printing equipment may be small enough that they can be housed in a dental office thereby allowing the dental aligners or retainers to be customized and direct printed immediately without the patient having to wait and to receive the dental alignment device at a later time.

In one embodiment, a process of making an object such as a dental aligner includes at least the following steps: (a) selecting a solid or rigid thermoplastic having enhanced creep properties; (b) grinding the solid or rigid thermoplastic into a fine powder; (c) selecting a powder bed fusion (PBF) 3D printing equipment or system that can transform the fine powder thermoplastic into a solid object having a desired shape; and (d) utilizing a 3D printing software in conjunction with the PBF 3D printing equipment or system to convert the fine powder thermoplastic into the solid object with the desired shape. An embodiment provides a process whereby the solid object is a dental aligner having the corresponding desired shape of a dental aligner that fits inside a patient's mouth and traditionally made from a film/mold process.

In one embodiment, the solid or rigid thermoplastic may be clear or transparent. In this embodiment, the solid or rigid thermoplastic is polysulfone. In one embodiment, the solid or rigid thermoplastic of the selecting step (a) can be in pellet form. In this embodiment, the grinding step (b) can be carried out by cryogenically grinding the pellet into fine powder form.

In one embodiment, the selecting step (c) and the utilizing step (d) can be carried out by determining the treatment goals for patients and establish virtual dental alignment and management plans for clear dental aligners via the 3D printing software and executing the manufacturing instructions via the PBF 3D printing equipment or system.

In some embodiments, the PBF 3D printing equipment or system can be selected from at least one of Formlabs, Stratasys, Sintratec, Sinterit, Red Rock 3D, Sharebot, Natural Robotics, Farsoon Technologies, Nexa 3D, HP (multi-jet fusion), 3D Systems, Eplus3D, Prodways Promake, Wematter Gravity, and EOS, to name a few. In other embodiments, the 3D printing software can be selected from at least one of Maestro 3D, 3Shape Ortho System, Simplify3D and eXceed Pro Software, to name a few. Alternatively, the 3D printing software can be integrated with the corresponding SLS 3D printing equipment or system.

In one embodiment, the dental aligner can be opaque or substantially opaque. In another embodiment, the resulting dental aligner can be clear or substantially transparent. In yet another embodiment, the resulting dental aligner can facilitate the teeth or dental treatment of a patient.

In one embodiment, a method of creating a dental object includes a providing step of providing a polymer in powder form, and forming an object, such as a dental aligner, in solid form from the powder form of the polymer, whereby the polymer of the object has a stress relaxation of less than about 40% decrease in stress at an applied strain of about 4% over about 24 hours.

In another embodiment, the forming step includes forming the object such that the polymer of the object has tensile strength of greater than about 48 MPa and tensile elongation of greater than about 40%.

In some embodiments, the providing step of providing the polymer includes the steps of producing the polymer as at least one of thermoplastic film, sheet and filament via an extrusion process, converting the at least one of thermoplastic film, sheet and filament into pellets via at least one of grinding, chopping and cutting, freezing the pellets via cryogenic process, and grinding the pellets into the powder form.

In one embodiment, the methods described above further includes tinting the at least one of thermoplastic film, sheet and filament with a coloring agent. The tinting step can be carried out during the producing step or the converting step above.

In some embodiments, the providing step of providing the polymer includes providing the polymer as at least one of polysulfone (PSU), polyethersulfone (PES/PESU), polyphenylsulfone (PPSU), polyetherimide (PEI), polyester and polyamide, among other thermoplastic materials.

In one embodiment, the forming step of, forming the object in solid form from the powder form, further includes sintering the powder form with a laser in a three-dimensional (3D) printing equipment in conjunction with a 3D printing software.

In one embodiment, the forming step of forming the object includes forming a substantially transparent dental aligner, where the dental aligner can be used to facilitate teeth alignment treatment of a patient. In one embodiment, the forming step includes heat forming the powder form of the polymer and excludes thermoforming on molds or curing a thermoset liquid or powder form of the polymer.

In another embodiment, presently disclosed methods can produce solid thermoplastic fine powders that comply with recognized extractable and leachable toxicity standards for which curing thermoset polymers used in 3D systems would be insufficient. In yet another embodiment, presently disclosed methods can produce solid thermoplastic fine powders made into solid forms via selective laser sintering allowing for tough, elastic polymer selections for which liquid or cured thermoset polymer systems would be insufficient.

In one embodiment, a method of creating a dental object such as a dental aligner includes a providing step of providing a polymer in powder form and forming the object in solid form from the powder form of the polymer. The solid form of the polymer used in forming the object may demonstrate at least the following properties: tensile strength of greater than about 48 MPa, tensile elongation of greater than about 40%, and stress relaxation of less than about 40% decrease in stress at an applied strain of about 4% over about 24 hours.

In one embodiment, a method of creating a dental object such as a dental aligner includes providing a polymer as at least one of thermoplastic film, sheet and filament via extrusion process, converting the at least one of thermoplastic film, sheet and filament into pellets via at least one of grinding, chopping and cutting, freezing the pellets via cryogenic process, grinding the pellets into the powder form, and sintering the powder form of the polymer with a laser in a three-dimensional (3D) printing equipment in conjunction with a 3D printing software to produce the object in solid form.

In some embodiments, the object can exhibit tensile strength of greater than about 48 MPa, tensile elongation of greater than about 40%, and stress relaxation of less than about 40% decrease in stress at an applied strain of about 4% over about 24 hours.

In some embodiments, the providing step of providing the polymer includes providing polymers that are compliant with Food and Drug Administration (FDA) biocompatibility U.S. Pharmacopeia (USP) Class VI, and/or ISO 10993, standards.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings.

FIG. 1 is a flow diagram of various embodiments of making an object such as a dental aligner according to the present disclosure.

FIG. 2 is a table showing the results of a 4% stress relaxation of various polymeric materials according to the present disclosure.

FIG. 3 is a table showing the results of a 4% stress relaxation of area under the curve of various polymeric materials according to the present disclosure.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

### Definitions

As used in this specification and the appended claims, the singular forms “a,” “an” and “the” include plural referents unless the content clearly dictates otherwise. For example, reference to “a cell” includes a combination of two or more cells, and the like.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

As used herein the term “consisting essentially of” refers to those elements required for a given embodiment. The term permits the presence of additional elements that do not materially affect the basic and novel or functional characteristic(s) of that embodiment of the invention.

The term “dental aligner” as used herein, refers to a plastic orthodontic appliance that is shaped to fit over one's teeth and is used to correct or adjust the alignment of one's teeth. Dental aligners can be made of a variety of plastic material and the material can be opaque, transparent, semi-transparent, non-transparent, or combinations thereof.

The term “3D printing” as used herein refers to an additive manufacturing process for making three-dimensional (3D) solid objects from a digital file. The creation of a 3D printed object can be/is achieved using additive processes. In an additive process, an object is created by laying down successive layers of material until the object is created. Each of these layers can be seen as a thinly sliced cross-section of the object. A 3D printing process is generally the opposite of subtractive manufacturing which is cutting out/hollowing out a piece of metal or plastic with for instance a milling machine. A 3D printing process enables producing complex shapes using less material than traditional manufacturing methods.

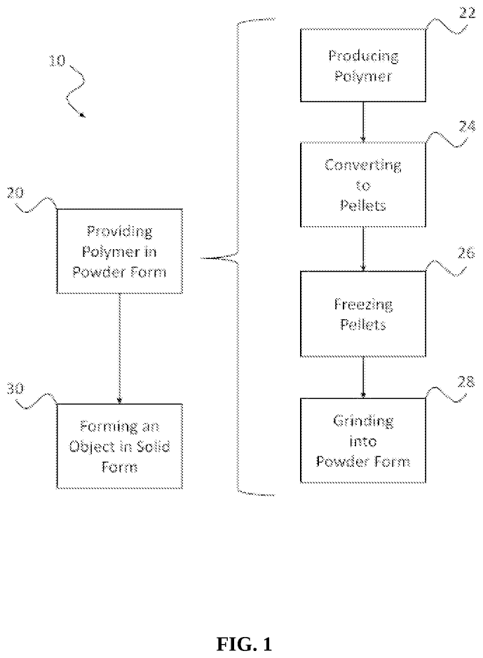

FIG. 1 is a flow diagram 10 of various embodiments of making an object such as a retainer or a dental aligner according to the present disclosure. In one embodiment, the resulting object can be a substantially clear or transparent dental aligner, in solid form, whereby the dental aligner facilitates teeth alignment treatment of a patient. In one embodiment, a method starts with a providing step 20 of providing a polymeric material in powder form followed by a forming step of forming an object in solid form from the powder form of the polymeric material, the object having stress relaxation of less than about 40% decrease in stress at an applied strain of about 4% over about 24 hours. In some embodiments, the polymeric material used in forming the object can exhibit stress relaxation of less than about 45% decrease in stress, or less than about 50% decrease in stress, or less than about 55% decrease in stress, at an applied strain of about 5%, or about 6% or higher, over about 48 hours, or over about 72 hours or longer.

Stress relaxation is a time-dependent decrease in stress under a constant strain. This characteristic behavior of a polymer can be studied by applying a fixed amount of deformation to a specimen and measuring the load required to maintain it as a function of time. In one embodiment, an initial load can be measured, in pound-force (lbf), at an applied strain of about 4%, to a variety of polymeric materials. The stress relaxation percentage can subsequently be measured after applying this constant strain over a period of time, e.g., about 24 hours, about 48 hours or about 72 hours or longer, in order to determine the stress relaxation of the polymeric material.

In some embodiments, the resulting object from the forming step 30 includes the polymer used in forming the object having tensile strength of greater than about 48 MPa and tensile elongation of greater than about 40%. In other embodiments, the polymer used in forming the object may have tensile strength of greater than about 40 MPa, or greater than about 45 MPa, or greater than about 50 MPa, and tensile elongation of greater than about 45%, or greater than about 50%, or greater than about 55%.

In one embodiment, the providing step 20 may include the following steps: producing step 21 whereby the polymer is produced as at least one of thermoplastic film, sheet and filament. In these instances, the polymer or thermoplastic material is produced in its solid form as a film, sheet or filament. For example, the thermoplastic material can be formed in a polymer reactor via an extrusion process by extruding a monomer to polymer and subsequently into filament form.

In one embodiment, the solid form of the polymer, whether as a film, sheet or filament, can be tinted with a coloring agent. In general, the polymer can be slightly yellow or brown, or may not be completely transparent. By tinting the polymer with a coloring agent, for example, blue color dye or other suitable color, the underlying coloration of the polymer can be converted to clear or substantially clear such that the resulting dental aligner can be substantially transparent so as to be aesthetically pleasing, if so desired. In some embodiments, the polymer can be tinted to different colors, or made opaque, or opaque in color, according to the patients' preference.

The producing step 21 can be followed by a converting step 23, whereby the at least one of thermoplastic film, sheet and filament can be converted into pellets by at least one of grinding, chopping and cutting processes. For example, the polymeric filament can be chopped into pellets of the appropriate size. In some instances, the tinting process described above can also be carried out during the converting step 23. In other instances, the tinting process includes tinting the thermoplastic material with a coloring agent in a monomer reaction or during pellet extrusion.

The converting step 23 is subsequently followed by a freezing step 25, whereby the pellets are frozen via cryogenic processing. In one embodiment, the freezing of pellets can be carried out via specialty convertors. Alternatively, the pellets may be kept at room temperature and converted into powder form via grinding or roto milling. Next, the frozen pellets can be grounded into powder form in a grinding step 27. Like above, the grinding step 27 can also be carried out via specialty convertors. Once grounded, the powder form of the thermoplastic material can be used in the providing step 20 as described above.

In some embodiments, cryogenic grinding, sometimes referred to as freezer milling, freezer grinding, or cryo-milling, may be used. Cryogenic grinding involves the process of cooling or chilling a thermoplastic material and then reducing it to small particle sizes. For example, thermoplastics are difficult to grind to small particles sizes at ambient temperatures because they can be soft and can sometimes adhere in lumpy masses and clog screens during the grinding process. By chilling the thermoplastics, in pellet form, with dry ice, liquid carbon dioxide, liquid nitrogen or other suitable cooling agent, the pellets can be grounded into suitable powder form for subsequent processing.

Polymers can exhibit a phenomenon known as creep, which describes how polymers strain under constant stress. When a polymeric material is continuously exposed to stress, its dimensions can change in response to the stress. The immediate dimensional change that occurs when the load is applied can be estimated from the elastic modulus. If the stress is maintained, the dimensions continue to change. The continual response to the stress can be commonly called creep and is typically monitored by measuring the strain as a function of time.

For example, a dental aligner can be made of a thermoplastic material which can be expanded or stretched by about four percent (4%) to exert a stress force of about 100 MPa. While the dental aligner is initially able to exert about 100 pounds of force on a patient's teeth, the thermoplastic eventually “creeps” and the amount of force that can be exerted by the material drops or decays over time. In other words, the material may only exert about 50 pounds of force after 5 hours, or about 40 pounds of force after 15 hours, and so forth, as the teeth move and are corrected throughout the treatment plan.

Eventually, the higher the creep the faster or greater the decrease in force that can be exerted, which can lead to aligner inefficiency. For instance, when the dental aligner is no longer able to exert the necessary force to carry out the alignment, the dental aligner will need to be replaced with a new dental aligner (or recycle existing dental aligner by reheating and reforming) to continue treatment. This adds variability to dental alignment therapy often resulting in costly mid-course corrections. In short, the faster or greater the force decay with time, the higher the creep properties. As such, the dental aligner needs to be made of thermoplastics with low or stable creep properties, which means little to minimal force decay with time so that the dental aligner is able to continuously exert the designed forces for purposes of correcting one's teeth. In some embodiments, the thermoplastic may have improved creep resistance. In other words, the thermoplastic can be quite resistant to force decay over time.

In some embodiments, the powder form of the polymer that can be used in the providing step 20 includes at least one of polysulfone (PSU), polyethersulfone (PES/PESU), polyphenylsulfone (PPSU), polyetherimide (PEI), polyester and polyamide. These polymeric materials are substantially clear or transparent or can be tinted accordingly such that the resulting dental aligner object can be substantially clear or transparent. Additionally, these polymeric materials may also be FDA approved with high operating temperatures (e.g., polysulfone up to about 160° C.) with high mechanical strength and rigidity. In some instances, these polymeric materials may exhibit enhanced creep properties or have good creep strengths (e.g., resisting creep and deformation) under continuous load even at elevated temperatures, in chemical environments, demonstrate excellent dimensional stability, exhibit resistance to hydrolysis (steam sterilization and steam resistant) and have good chemical compatibility and be radiation resistant.

In one embodiment, the forming step 30 of the dental aligner object in solid form can be carried out via an additive manufacturing process, where the step involves adding layers of a molten powder form of the polymer in a 3D printing equipment in conjunction with a 3D printing software. In some instances, the forming process may be powder bed fusion (PBF). In a preferred embodiment, a technique of PBF, multi jet fusion (MJF) is utilized. In another embodiment, selective laser sintering (SLS), is utilized. In one embodiment, the 3D printing involves selecting a 3D printing equipment or system that transforms thermoplastic powders into an object of desired shape whereby the 3D printer can be affordable and sized to be housed within a dental clinic or office (e.g., desktop size). In addition, fuse deposition modeling (FDM) could be used in the future to improve bonding between extruded layers. Depending on the forming process utilized, it may also be advantageous to implement an atomization process (Step 29) after rotor milling or cryogenesis in order to achieve powder particulates with improved spherical morphology.

In one embodiment, the minimum dimension size of the 3D printer build area should be at least 10 cm×10 cm×10 cm to allow room for the layer-by-layer build-up of retainers or dental aligners within the 3D printer. In some embodiments, the size of the 3D printer can be smaller or bigger than 10 cubic centimeters (cm 3).

In one embodiment, the 3D printer should be capable of making minimum layer thicknesses of less than about 0.1 mm. In another embodiment, the 3D printer should have a laser source that is capable of sintering the thermoplastic materials described above, namely, polysulfone (PSU), polyethersulfone (PES/PESU), polyphenylsulfone (PPSU), polyetherimide (PEI), polyester and polyamide, among other thermoplastic elastomers and thermoplastic rubbers. In these instances, the laser source may have an output power of at least about 10 W or greater.

In one embodiment, the 3D printer may have its own 3D printing software integrated therewith. In other embodiments, the 3D printer and the 3D printing software may be separately operated. In one embodiment, the 3D printing software can be used in conjunction with the 3D printing equipment to transform the fine thermoplastic powder into an object with a desired shape such as that of a dental aligner or a dental retainer.

In one embodiment, the 3D printing software is capable of utilizing intraoral scanning such that a patient's teeth can be scanned and electronically digitized. Once digitized, a corresponding 3D mapping of an object to fit the scanned and digitized set of teeth can be electronically generated. This corresponding 3D mapping of the object will be used to create the dental aligner, which has been mapped along its three dimensions (x-axis, y-axis and z-axis) that complements the outline shapes and structure of the patient's teeth. For example, the 3D mapping of the dental aligner can be automatically calculated and generated so as to have constant thickness along all three dimensions in forming the object via 3D printing. Alternatively, the 3D mapping of the dental aligner can be adjusted so as to have different or varying thicknesses. Once the 3D mapping has been generated, the corresponding instructions for printing the dental aligner using the 3D printer, can be electronically communicated, from the 3D printing software to the 3D printer, in executing the direct printing process. And because the object is 3D mapped based on the patient's teeth, the resulting object will have minimal mismatch issues to provide complementary fit.

In general, thermoset plastics can undergo chemical reactions by, for example, heat, catalyst or ultraviolet light. In one embodiment, the thermoplastic material according to the current disclosure can be heat formed, during the forming step 30, using a laser source such that the powder form of the thermoplastic can be converted to its solid form by heat from the laser source. In other words, the laser source heats up the powder form, by heat forming, and once the laser source is removed, the powder form of the thermoplastic cools into a precise form thereof. In other embodiments, besides a laser source other heat sources may be utilized during the forming step 30.

In these instances, heat forming is different from thermoforming on molds or curing a thermoset liquid or powder form of the polymer. In other words, the forming step 30 excludes thermoforming on molds or curing a thermoset liquid or powder form of the polymer. Thermoforming on molds generally involves scanning the teeth and creating a 3D model via scanning, transferring the scanned data and printing the 3D model therefrom. The 3D model is used as a “mold” such that an extruded thermoplastic sheet can be formed thereon by heating the sheet to its softening point, stretching and manipulating across the mold, and allowing the sheet to cool to a desired shape that complements the outline of the shape of the mold. Curing a thermoset liquid or powder form of the polymer involves processing a thermoset polymer that starts out as viscous liquid or liquid monomers. The viscous liquid form of the thermoset polymer becomes irreversibly hardened when cured due to heating, ultraviolet light, high pressure or other catalysts, and combinations thereof, thereby curing the viscous liquid form into a permanent, solid form of the polymer. These techniques are contemplated to be excluded from the forming step 30 according to the present disclosure.

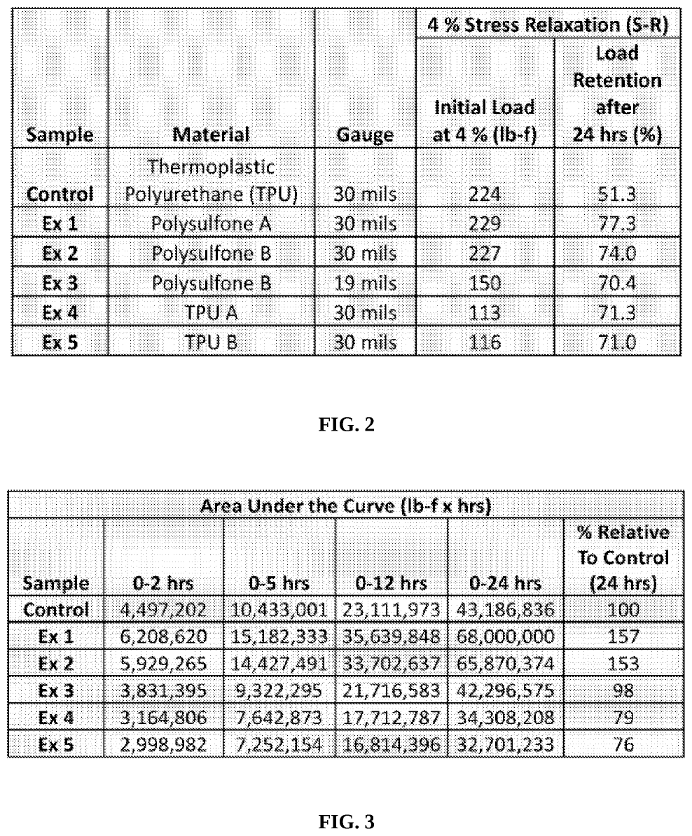

FIG. 2 is a table showing the results of a 4% stress relaxation of various polymeric materials according to the present disclosure. The control is a thermoplastic polyurethane (TPU) material that is a commercially available and indicative of the current state of dental aligners manufactured with such material. The various exemplaries in the table demonstrate the improved integrity of thermoplastics (e.g., polysulfone) according to the present disclosure in a stress relaxation (S-R) test where an initial applied load is largely maintained over time allowing the dental aligner appliance to be more accurately designed for alignment therapy and do more work moving the teeth in shorter time during the course of treatment.

As measured against the TPU control, polysulfone A and B (exemplaries 1 and 2), at the same gauge thickness of 30 mils, are able to demonstrate improved stress relaxation at 4% strain after about 24 hours and substantially maintain its load retention even after such load and time. Furthermore, polysulfone B (exemplary 3), at a different gauge thickness (19 mils v. 30 mils), while having lower initial load is nevertheless able to deliver comparable stress relaxation performance to exemplaries 1 and 2. Lastly, TPU A and B (exemplaries 4 and 5), while having lower initial loads are nevertheless able to produce comparable stress relaxation to that of the polysulfone thermoplastics.

FIG. 3 is a table showing the results of a 4% stress relaxation of area under the curve of various polymeric materials according to the present disclosure. The stress relaxation test is performed using a tensile test method where the specimen is held at about 4% strain for about 24 hours. The “work” value is achieved by calculating the area under the resulting stress-strain curve (area under the curve) for a given period of duration, which is 24 hours in this instance. This area under the curve represents the stress in pound-force (lb-f) applied over time (hours) to the teeth. The larger the area, the more effective the appliance is at applying tooth-moving forces over time.

As measured against the TPU control, polysulfone A and B (exemplaries 1 and 2), at the same gauge thickness of 30 mils, are able to demonstrate improved performance by applying over 50% more force (e.g., 57% and 53% more force than control, respectively) than the TPU control over the course of about 24 hours. Polysulfone B (exemplary 3), even at a different gauge thickness (19 mils v. 30 mils) to the TPU control, is nevertheless able to deliver comparable performance at about 98% of the work as that of a commercial dental aligner but with about 36% reduced thickness (11 mils thinner), which is indicative that dental aligners made with presently disclosed thermoplastics (e.g., polysulfone) can match the performance of currently available dental aligners without the added thickness which may result in a dental aligner that can be made thinner so as to enhance its comfort when used by the patient. Lastly, TPU A and B (exemplaries 4 and 5) appear to deliver poor results relative to the TPU control by at least about 20% less force (e.g., 21% and 24% less force than control, respectively).

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the present invention.

What is claimed is:

1. A method comprising:
providing a polymer in powder form; and
forming an object in solid form from the powder form, the object having stress relaxation of less than about 40% decrease in stress at an applied strain of about 4% over about 24 hours.

2. The method of claim 1, wherein the forming step includes forming the object having tensile strength of greater than about 48 MPa and tensile elongation of greater than about 40%.

3. The method of claim 1, wherein the providing step further comprises:
producing the polymer as at least one of thermoplastic film, sheet and filament via extrusion process;
converting the at least one of thermoplastic film, sheet and filament into pellets via at least one of milling, pulverizing, grinding, chopping and cutting;
freezing the pellets via a cryogenic process; and
grinding the pellets into the powder form.

4. The method of claim 3, further comprising tinting the at least one of thermoplastic film, sheet and filament with a coloring agent.

5. The method of claim 1, wherein the providing step further comprises:
producing the polymer as at least one of thermoplastic film, sheet and filament via extrusion process;
converting the at least one of thermoplastic film, sheet and filament into room temperature pellets via at least one of milling, pulverizing, grinding, chopping and cutting
converting the room temperature pellets into powder via one or grinding or roto-milling.

6. The method of claim 4, further comprising tinting the at least one of thermoplastic film, sheet and filament with a coloring agent.

7. The method of claim 1, wherein the providing step includes providing the polymer as at least one of polysulfone (PSU), polyethersulfone (PES/PESU), polyphenylsulfone (PPSU), polyetherimide (PEI), polyester and polyamide.

8. The method of claim 1, wherein the forming step further comprises fusing the powder form in a three-dimensional (3D) printing equipment in conjunction with a 3D printing software.

9. The method of claim 1, wherein the forming step of forming the object includes forming a substantially transparent dental aligner, and wherein the dental aligner facilitates teeth alignment treatment.

10. The method of claim 1, wherein the forming step includes heat forming the powder form and excludes thermoforming on molds or curing a thermoset liquid or powder form of the polymer.

11. A method comprising:
providing a polymer in powder form; and
forming an object in solid form from the powder form, the object having tensile strength of greater than about 48 MPa, tensile elongation of greater than about 40%, and stress relaxation of less than about 40% decrease in stress at an applied strain of about 4% over about 24 hours.

12. The method of claim 11, wherein the providing step further comprises:
providing the polymer as at least one of thermoplastic film, sheet and filament via extrusion process;
converting the at least one of thermoplastic film, sheet and filament into pellets via at least one of grinding, chopping and cutting; and
grinding the pellets into the powder form.

13. The method of claim 12, further comprising the step of freezing the pellets via a cryogenic process.

14. The method of claim 13, further comprising tinting the at least one of thermoplastic film, sheet and filament with a coloring agent.

15. The method of claim 11, wherein the providing step includes providing the polymer as at least one of polysulfone (PSU), polyethersulfone (PES/PESU), polyphenylsulfone (PPSU), polyetherimide (PEI), polyester and polyamide.

16. The method of claim 11, wherein the forming step further comprises sintering the powder form with a laser in a three-dimensional (3D) printing equipment in conjunction with a 3D printing software.

17. The method of claim 11, wherein the forming step of forming the object includes forming a substantially transparent dental aligner, and wherein the dental aligner facilitates teeth alignment treatment.

18. The method of claim 11, wherein the forming step includes heat forming the powder form and excludes thermoforming on molds or curing a thermoset liquid or powder form of the polymer.

19. A method comprising:
providing a polymer as at least one of thermoplastic film, sheet and filament via extrusion process;
converting the at least one of thermoplastic film, sheet and filament into pellets via at least one of grinding, chopping and cutting;
grinding the pellets into polymeric particulates; and
fusing the polymeric particulates in a three-dimensional (3D) printing equipment in conjunction with a 3D printing software to produce an object in solid form, the object having tensile strength of greater than about 48 MPa, tensile elongation of greater than about 40%, and stress relaxation of less than about 40% decrease in stress at an applied strain of about 4% over about 24 hours.

20. The method of claim 19, further comprising the step of freezing the pellets via a cryogenic process.

21. The method of claim 20, further comprising tinting the at least one of thermoplastic film, sheet and filament with a coloring agent.

22. The method of claim 20, wherein the providing step includes providing the polymer as at least one of polysulfone (PSU), polyethersulfone (PES/PESU), polyphenylsulfone (PPSU), polyetherimide (PEI), polyester and polyamide.

23. The method of claim 20, wherein the forming step of forming the object includes forming a substantially transparent dental aligner, and wherein the dental aligner facilitates teeth alignment treatment.

24. The method of claim 20, wherein the forming step includes heat forming the polymeric particulates and excludes thermoforming on molds or curing a thermoset liquid or powder form of the polymer.

25. The method of claim 20, wherein the forming step utilizes one of multi jet fusion and selective laser sintering.

26. The method of claim 25, further comprising the step of atomizing the polymeric particulates before the step of fusing.
